(19) United States
(12) Patent Application Publication
(10) Pub. No.: US 2009/0034958 A1
(43) Pub. Date: Feb. 5, 2009

(54) Gaze Attracting System for Image Capturing

(76) Inventor: Karl Allen Dierenbach, Centennial, CO (US)

Correspondence Address: KARL ALLEN DIERENBACH, 7587 SOUTH XANTHIA COURT, CENTENNIAL, CO, 80112, US

(21) Appl. No.: 11/830,002

(22) Filed: Jul. 30, 2007

(51) Int. Cl. G03B 15/03

(52) U.S. Cl. 396/199; 362/11

(57) ABSTRACT

An apparatus for attracting the gaze of a subject to be photographed is disclosed. The subject may, for example, be an infant, young child or pet. The apparatus may include a plurality of light sources disposed about a lens of the image-capturing device. Once activated, the device may cause one or more of the plurality of light sources to flash, thereby attracting the gaze of the subject. Once the gaze is attracted, an image of the subject may be captured where the subject is looking into the camera lens. The plurality of light sources may be light emitting diodes (LEDs). The apparatus may be operable to be mounted to an existing lens. The apparatus may be a lens or camera with the plurality of light sources attached.

### BACKGROUND

Photography of infants and young children is often accompanied by efforts to attract the gaze of the subject toward the camera. Such efforts include having a parent stand near the camera to attract the subject's attention. In cases where the parent is the photographer, the efforts may include calling to the subject and leaning out from behind the camera so that the subject may see the photographer's face. Other efforts included waving toys or other items in the vicinity of the camera to attract the gaze of the subject in the general vicinity of the camera.

The flash unit of a camera has been used to attempt to attract the gaze of subjects. For example, U.S. Pat. No. 5,051,763 to Yukevich, Jr. employs two separate flashes. The first flash is to capture the attention of a subject and the second flash is to illuminate the subject when capturing an image.

### SUMMARY

An object of embodiments described herein is to provide improved methods and apparatuses for attracting the gaze of a subject to be photographed. Embodiments described herein may be capable of attracting the gaze of a subject so that the subject is looking directly at a lens of an image-capturing device at the moment the image-capturing device is capturing an image. The subject may be any subject whose gaze is desired to be directed toward the image-capturing device. Although the subject is generally described herein as an infant, the subject may also, for example, be a young child or an animal such as a pet. The image-capturing device may be a camera (e.g., digital or film), a video camera, or any other device used to capture images.

Embodiments of the present invention described herein include light sources disposed about a lens of an image-capturing device. The light sources may flash and/or sequentially light in a plurality of patterns. Some of the patterns may simulate movement about the lens. The light sources may be illuminated independently of any image capturing cycle. The light sources may be illuminated independently during the image capturing cycle.

Embodiments of the present invention described herein represent improved systems and methods of attracting the gaze of a subject directly at a lens on an image-capturing device. For example, the well-known technique of waving a toy or other object while photographing an infant may attract the gaze of the infant, but that gaze will be attracted to the toy, not the lens. The subsequently captured image will be of the subject not gazing into the lens. In contrast, embodiments described herein include arrangements of light sources about the lens, which when activated, attract the gaze of the subject directly into the lens. Embodiments described do not use a flash or other light source used to illuminate a subject during image capture to attract the gaze of the subject. Therefore, the embodiments are not constrained to the color or other attribute of the flash or other light source used to illuminate a subject during image capture. Furthermore, flashes or other light sources used to illuminate a subject during image capture frequently have high power requirements and are incapable of simulating movement about the lens. Embodiments described herein may be of a lower light level and use low power light sources (such as light emitting diodes (LEDs)). Moreover, embodiments described herein may be illuminated independently of any image capturing cycle, which allows the gaze attracting apparatus to be used in a variety of unique ways. For example, the gaze attracting apparatus may be used until the subject has a look of delight, wonderment, or other emotion, at which time the user may selectively capture an image. The user may activate the gaze attracting apparatus and then only capture an image when the subject is looking into the lens and has a satisfactory expression. Furthermore, the gaze attracting apparatus may be continued to be activated during and after image capture in preparation for capture of a subsequent image. The light output of the gaze attracting apparatus may be below a threshold such that light from the gaze attracting apparatus may not appear in the captured image.

In an aspect of the present invention, an apparatus for attracting the gaze of a subject during capture of an image of the subject is provided. The apparatus may include a power source, a plurality of light sources, and a switch. The plurality of light sources may be operable to be interconnected about a lens of an imaging device. The switch may be interconnected to the power source and the plurality of light sources. Activation of the switch may result in at least a portion of the plurality of light sources being illuminated.

In an embodiment, the power source may comprise one or more batteries. In an embodiment, the imaging device may be a camera. In an embodiment, each of the plurality of light sources may be an LED. In an embodiment, each of the plurality of light sources may be a colored light source. In an embodiment, each of the plurality of light sources may be a colored LED.

In an arrangement the plurality of light sources may be operable to be arranged in circular pattern. The diameter of the circular pattern may be adjustable. The plurality of light sources may be operable to fit around the lens of the imaging device. The apparatus may further include a control module that may be operable to flash one or more of the plurality of light sources. The control module may be operable to individually light each of the plurality of light sources.

In an embodiment, a control module may be included wherein the control module may be operable to flash one or more of the plurality of light sources. The control module may be operable to individually control each of the plurality of light sources. The control module may be operable to sequentially light each of the plurality of light sources. Activation of the switch may cause the control module to flash one or more of the plurality of light sources while the switch is activated. Activation of the switch may cause the control module to flash one or more of the plurality of light sources a plurality of times while the switch is activated. Activation of the switch may cause the control module to flash one or more of the plurality of light sources after the switch is activated. Activation of the switch may cause the control module to flash one or more of the plurality of light sources a plurality of times after the switch is activated.

In an arrangement, the total maximum luminous intensity of all of the plurality of light sources combined may be at most 1,000 millicandela. Furthermore, the total maximum luminous intensity of all of the plurality of light sources combined may be at most 100 millicandela.

In an embodiment, the activation of the switch may result in two or more of the plurality of light sources being sequentially illuminated. The activation of the switch may result in the plurality of light sources being illuminated in a pattern that simulates movement about the lens when the plurality of light sources are interconnected about the lens. The switch may be a momentary closure switch and activation of the switch may cause each of the plurality of light sources to be illuminated while the switch is activated. The switch may be a momentary closure switch and activation of the switch may cause each of the plurality of light sources to be illuminated for a predeterminable amount of time.

In an arrangement, the apparatus may further include a sound module that includes a speaker, a playback device operable to drive the speaker, and a memory operable to store information related to one or more sounds to be played by the playback device over the speaker. The sound module may be operable to play sound synchronized to the operation of the plurality of light sources.

In another aspect, an apparatus for attracting the gaze of a subject during capture of an image of the subject is provided. The apparatus includes a power source, a plurality of light sources operable to be interconnected about a lens of an imaging device, and a control module operable to flash one or more of the plurality of light sources.

In an embodiment, the control module may be operable to individually control a sub-group of the plurality of light sources. The control module may be operable to individually control each of the plurality of light sources.

In an arrangement, the control module may be operable to sequentially light two or more of the plurality of light sources. In an arrangement, the control module may be operable to light the plurality of light sources in a pattern that simulates movement about the lens when the plurality of light sources are interconnected about the lens. In an arrangement, the control module may be operable to flash one or more of the plurality of light sources after receiving an initiation signal. In an arrangement, the control module may be operable to flash one or more of the plurality of light sources a plurality of times after receiving an initiation signal.

In still another aspect, a lens assembly is provided. The lens assembly includes a lens, a plurality of light sources interconnected about the lens, and a control module operable to flash one or more of the plurality of light sources. The plurality of light sources may be arranged in circular pattern about the lens.

In an arrangement, the control module may be operable to individually control a sub-group of the plurality of light sources. In an arrangement, the control module may be operable to sequentially light two or more of the plurality of light sources. In an arrangement, the control module may be operable to light the plurality of light sources in a pattern that simulates movement about the lens.

In yet another aspect, a camera is provided. The camera includes a lens, a plurality of light sources interconnected about the lens, and a control module operable to flash one or more of the plurality of light sources.

In an embodiment each of the plurality of light sources may be an LED. The LEDs may be colored. The plurality of light sources may be arranged in circular pattern about the lens.

In an arrangement, the total maximum luminous intensity of all of the plurality of light sources combined may be at most 1,000 millicandela. Furthermore, the total maximum luminous intensity of all of the plurality of light sources combined may be at most 100 millicandela.

In an embodiment, the control module may be operable to individually control a sub-group of the plurality of light sources. In an embodiment, the control module may be operable to sequentially light two or more of the plurality of light sources. In an embodiment, the control module may be operable to light the plurality of light sources in a pattern that simulates movement about the lens.

In another aspect, a method of capturing an image of a subject with a camera wherein the subject is gazing at a lens of the camera is provided. The method includes the steps of providing a plurality of light sources disposed proximate to and about the lens, illuminating at least a portion of the plurality of light sources to attract the gaze of the subject to the lens, and capturing an image of the subject while the gaze of the subject is directed at the lens.

In an embodiment of the current aspect, the illuminating step may include flashing at least a portion of the plurality of light sources. Furthermore, the illuminating may include flashing at least a portion of the plurality of light sources a plurality of times.

In an embodiment, the illuminating may be in a pattern that simulates movement about the lens. In an embodiment, the light sources may be un-illuminated during the capturing step.

The various features, arrangements and embodiments discussed above in relation to each aforementioned aspect may be utilized by any of the aforementioned aspects. Additional aspects and corresponding advantages will be apparent to those skilled in the art upon consideration of the further description that follows.

### BRIEF DESCRIPTION OF THE DRAWINGS

FIG. 1 illustrates an embodiment of a gaze attracting system for image capturing.

FIG. 2 is rear view of the gaze attracting system of FIG. 1.

FIGS. 3A and 3B illustrate the ability of the gaze attracting system of FIG. 1 to conform to differing diameters.

FIG. 4 is an illustration of another embodiment of a gaze attracting system.

FIG. 5 is an illustration of another embodiment of a gaze attracting system.

FIG. 6 is an illustration of a gaze attracting system for mounting on a compact camera.

FIG. 7 is an illustration of another embodiment of a gaze attracting system.

FIGS. 8A through 8L illustrate an exemplary manners of illuminating a gaze attracting system for image capturing.

FIG. 9 is an illustration of an embodiment of an exemplary system display.

FIG. 10 is a block diagram of an embodiment of a gaze attracting system for image capturing.

FIG. 11 is an illustration of another embodiment of a gaze attracting system.

### DETAILED DESCRIPTION

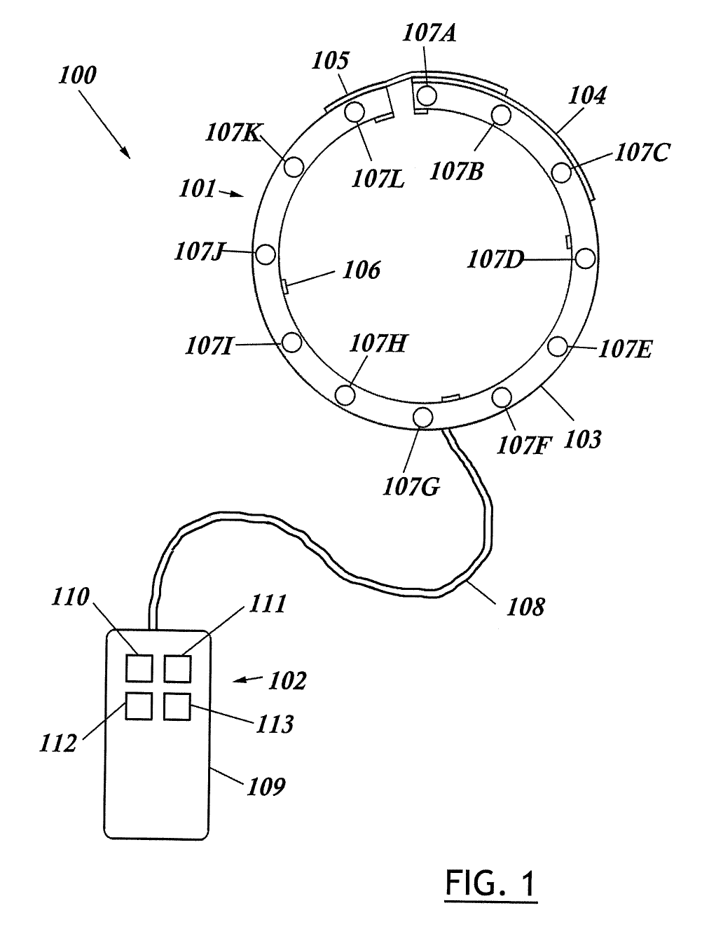

FIG. 1 is an illustration of an embodiment of a gaze attracting system 100 for attracting the gaze of a subject during image capturing. The gaze attracting system 100 includes an attracting member 101 and a control member 102. The attracting member 101 and a control member 102 are interconnected by a cable 108. The attracting member 101 may be operable to mount to a camera or camera lens and substantially surround the camera lens.

The attracting member 101 includes a plurality of light sources 107A through 107L. The plurality of light sources 107A through 107L may be operable to be illuminated in such a manner as to attract the gaze of a subject during image capturing. This may be achieved by illuminating one or more of the plurality of light sources 107A through 107L in a manner as described below. The illumination of one or more of the plurality of light sources 107A through 107L may attract the gaze of any live subject and is particularly well suited for attracting the gaze of infants and toddlers. Even brief illumination may attract the gaze of an infant or toddler for several moments, allowing the image capturer (e.g., photographer) to capture one or more images with the subject looking directly at the plurality of light sources 107A through 107L and hence directly at the lens of the image-capturing device. Moreover, a brief illumination of one or more of the plurality of light sources 107A through 107L may cause the subject to stare at the lens even when the plurality of light sources 107A through 107L are not illuminated due to, for example, curiosity or anticipation of future lighting.

The lighting of one or more of the plurality of light sources 107A through 107L may also serve to capture images of older subjects looking directly at the lens. For example, a photographer may approach a subject who is not aware of the photographers presence. The photographer may activate the one or more of the plurality of light sources 107A through 107L in such a manner to catch the attention of the subject who instinctively turns toward and looks at the lens, at which time the photographer may capture an image of the subject with the subject's gaze fixed on the lens. The lighting of one or more of the plurality of light sources 107A through 107L may also be operable to attract the gaze of an animal (e.g., a pet).

One or more of the plurality of light sources 107A through 107L may be illuminated to simulate movement, which may attract the gaze of the subject. In addition, the lighting of one or more of the plurality of light sources 107A through 107L can work on multiple subjects simultaneously, to enable group photography (e.g., groups including one or more infants, toddlers, pets, etc.) where each of the subjects is looking at the lens. The plurality of light sources 107A through 107L may be any appropriate light source. For example, the plurality of light sources 107A through 107L may each be LEDs or incandescent light bulbs. LEDs are well suited for this application due to their quick response time, low power consumption, reliability, and shock absorption capabilities.

FIG. 1 illustrates an attracting member 101 with twelve light sources, light sources 107A through 107L. A greater or lesser number of light sources may be present on the attracting member 101.

Control member 102 may be operable to control the illumination of the plurality of light sources 107A through 107L. As illustrated, the control member may contain buttons 110, 111, 112 and 113 which, when depressed may control various functions related to the gaze attracting system 100. Other control member 102 configurations may be utilized, including configurations with one or more displays, one or more indicator lights, and/or a different number of buttons than illustrated in FIG. 1. For example, in a simple form, the control member may contain a single button that when depressed, causes all of the plurality of light sources 107A through 107L to be illuminated. In such an arrangement, the image capturer may manually and repeatedly depress and release the one button to make all of the plurality of light sources 107A through 107L flash to attract the gaze of a subject. The embodiment illustrated in FIG. 1 contains four buttons 110, 111, 112 and 113, each of which may activate a different mode of lighting. For example, button 110 may act as the single button described above. Button 111 may cause all the plurality of light sources 107A through 107L to rapidly flash in unison until the button 11 is released. Button 112 may activate a slow pinwheel lighting pattern (described below) and button 113 may activate a fast pinwheel lighting pattern. The variety of lighting patterns available in the embodiment may enhance the ability of the gaze attracting system 100 to attract the gaze of subjects. For example, one lighting pattern may be more interesting to a particular subject than other patterns, and so that one lighting pattern may be used to successfully attract the gaze of that particular subject. For example, a particular subject may tire or get used to a particular pattern, in which case using a different pattern may surprise or catch the attention of that subject. In this regard, a photographer may frequently use different lighting patterns to lend unpredictability to the illumination of the plurality of light sources 107A through 107L, which may be attractive to the subject.

One or more of the buttons 110, 111, 112 and 113 may be momentary closure switches. As used herein, momentary closure switch refers to a switch that completes a circuit as long as the switch is activated. Upon release of the switch, the circuit is interrupted. In this regard, a momentary closure switch may be operable to complete a circuit for an extended period of time if the user activates the switch for an extended period of time. Alternatively, one or more of the buttons 110, 111, 112 and 113 may be other known types of switches.

The control member 102 may also house a power source for the operation of the gaze attracting system 100. For example, the control member 102 may house one or more batteries. The batteries may be mounted in the control member 102 within a case 109 and may be accessible by known methods (e.g., though a removable panel of the case 109). The number and type of batteries may be determined by power, battery life, and space requirements. For example, 3 size AAA batteries may be used to supply about 4.5 volts to the gaze attracting system 100. Or 2 size AAA batteries may be used if about 3 volts is desired. Other sizes of batteries, such as smaller button batteries or larger AA batteries may be used. The cable 108 may contain an appropriate number of conductors which may be determined by the desired lighting patterns for the plurality of light sources 107A through 107L. For example, if all of the plurality of light sources 107A through 107L are to be simultaneously lit, only two conductors may be present in the cable 108 and the plurality of light sources 107A through 107L may be interconnected in series. Alternatively, if each of the plurality of light sources 107A through 107L is desired to be independently lit and the control circuitry is located in the control member 102, the cable 108 may contain a number of conductors equal to the number of light sources 107A through 107L plus one. In this configuration, an individual conductor would run from the control member 102 to each of the plurality of light sources 107A through 107L and the plurality of light sources 107A through 107L would share a common return conductor.

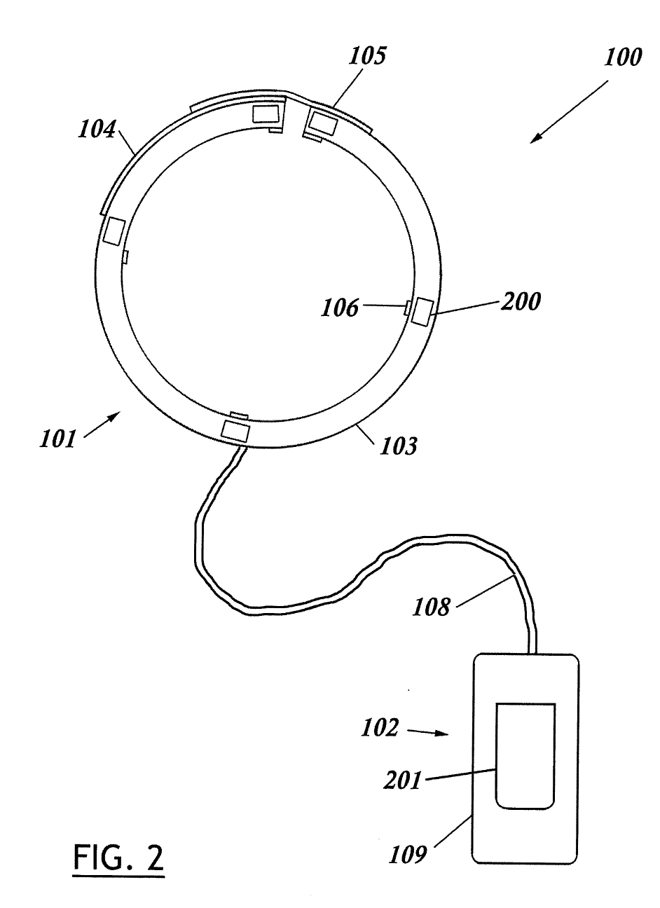

FIG. 2 is a rear view of the embodiment of FIG. 1. The control member 102 may contain a clip 201 (e.g., a type of clip typically used to attach to a belt or strap) to enable the control member 102 to be attached to, for example, a camera strap attached to a camera. Such an arrangement allows for quick and easy access to the buttons 110, 111, 112, and 113 of the control member 102 during photography.

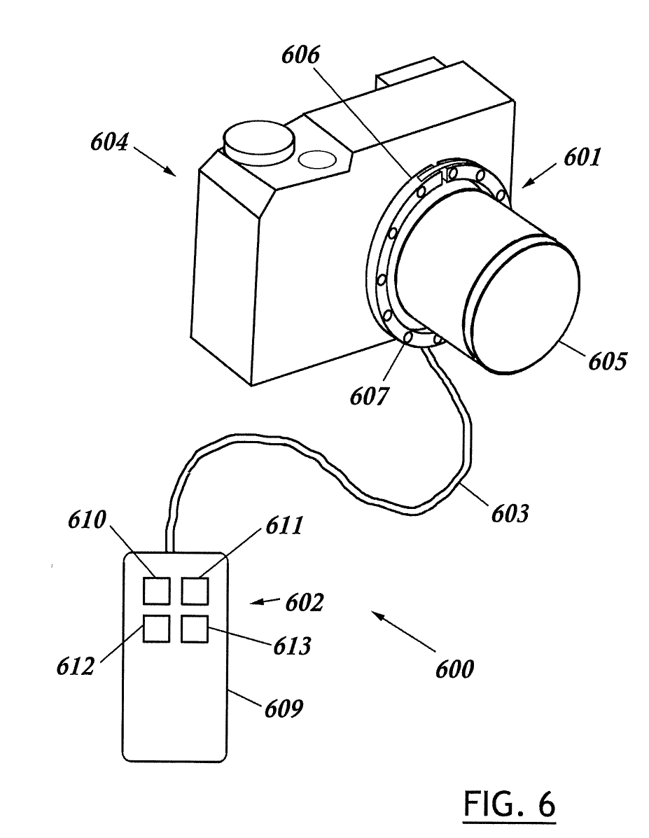

The attracting member 101 may include a flexible strip 103 to which the plurality of light sources 107A through 107L are mounted. The flexible strip 103 may be flexible enough to allow the attracting member 101 to be mounted to a variety of different diameter (and shaped) lenses. The flexible strip 103 may be a clear tube in which the plurality of light sources 107A through 107L are arranged. The flexible strip may be constructed of opaque materials and a portion of the plurality of light sources 107A through 107L may extend through a surface of the flexible strip 103. The flexible strip 103 may have a rectangular or square cross section and the plurality of light sources 107A through 107L may be mounted to one of the faces of the flexible strip 103. The latter type of arrangement is best illustrated in FIG. 6, discussed below.

The attracting member 101 may include a closure mechanism to allow the flexible strip 103 to be wrapped around a variety of different sized and shaped lenses. One such closure mechanism is illustrated in FIGS. 1 and 2. Complimentary pieces of hook and loop fastening materials 105 and 104 (e.g., velcro®) are attached to the flexible strip 103 in a manner such that the hook and loop fastening materials 104 and 105 are operable to secure the flexible strip at different diameters. In FIG. 1, the loop fastening material 104 is fixedly attached to the flexible strip 103 in the vicinity of light sources 107A through 107C with the loop portion facing outwardly, while the hook fastening material 105 is fixedly attached to the flexible strip 103 in the vicinity of light source 107L with the hook portion facing inwardly. Consequently, the diameter of the flexible strip 103 may be adjusted (e.g., it may be wrapped about a lens) and that diameter may be secured by contacting the hook fastening material 105 to the loop fastening material 104 as shown in FIGS. 1 and 2. Note that in any description contained herein regarding hook and loop fastening, the positioning of the hook and loop fasteners may be reversed (e.g., the hook fastener may be placed where the loop fastener is and vice versa).

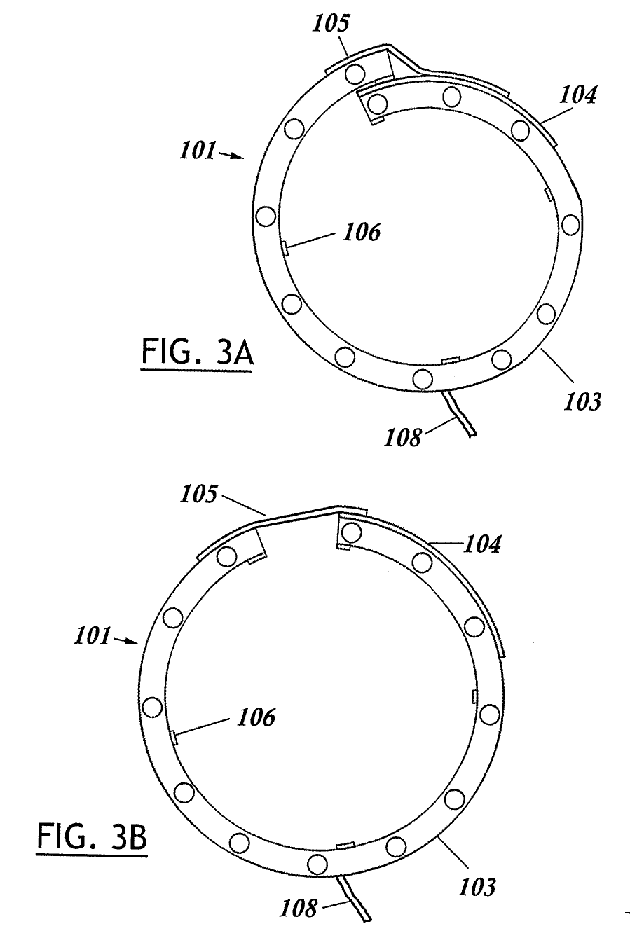

FIG. 3A illustrates the attracting member 101 of FIGS. 1 and 2 configured to fit around a smaller lens than the configuration of FIGS. 1 and 2. As will be appreciated, the flexible strip 103 in FIG. 3A is flexed about a smaller radius than as shown in FIGS. 1 and 2 to the point where the flexible strip 103 is wrapped about itself. However, the flexibility of the hook and loop fastening materials 104 and 105 allows such a configuration to be secured.

FIG. 3B illustrates the attracting member 101 of FIGS. 1 through 3 configured to fit around a larger lens than the configuration of FIGS. 1 and 2. As will be appreciated, the flexible strip 103 in FIG. 3B is flexed about a larger radius than as shown in FIGS. 1 and 2 to a point where the gap between the ends of the flexible strip is considerably larger than in FIGS. 1 and 2. However, the flexibility and length of the hook and loop fastening materials 104 and 105 allows such a configuration to be secured. Accordingly, it will be appreciated that the flexible strip 103 coupled with appropriately sized hook and loop fastening materials 104 and 105 will allow the attracting member 101 to be mounted around a wide variety of differently sized and shaped lenses.

The flexible strip 103 may be constructed of a material (such as rubber or a rubberized coating) that when in contact with a lens, will grip the lens thereby further securing the flexible strip 103 to the lens. Grip pads 106 may be mounted to the interior surface of the flexible strip 103. The grip pads 106 may be made of a compressible and/or high friction material such that when the grip pads 106 contact a lens, the flexible strip 103 will be secured to the lens.

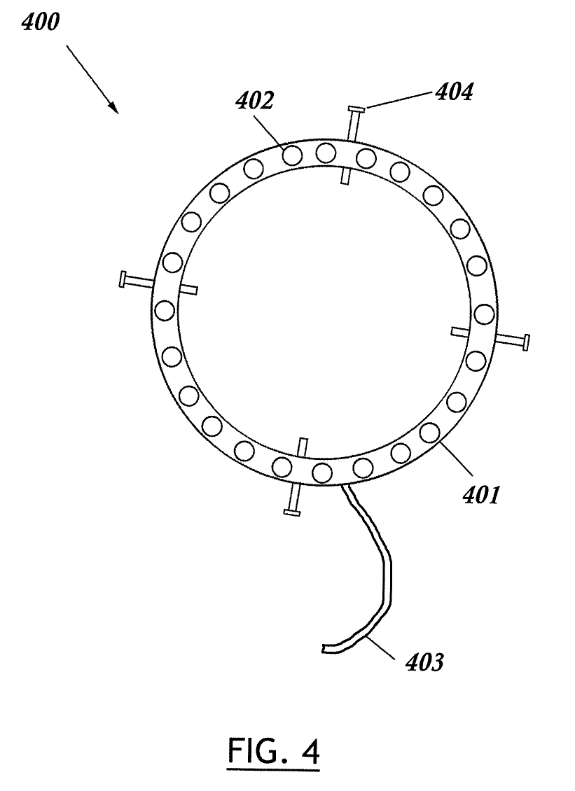

Other methods of mounting an attracting member may be utilized. For example, in FIG. 4, an attracting member 400 includes a solid ring 401 that includes a plurality of light sources (such as light source 402). To accommodate lenses of various sizes, the solid ring 401 includes a plurality of setscrews 404. The setscrews 404 may be adjusted to contact various sizes and shapes of lenses to allow the attracting member 400 to be mounted to a variety of lenses.

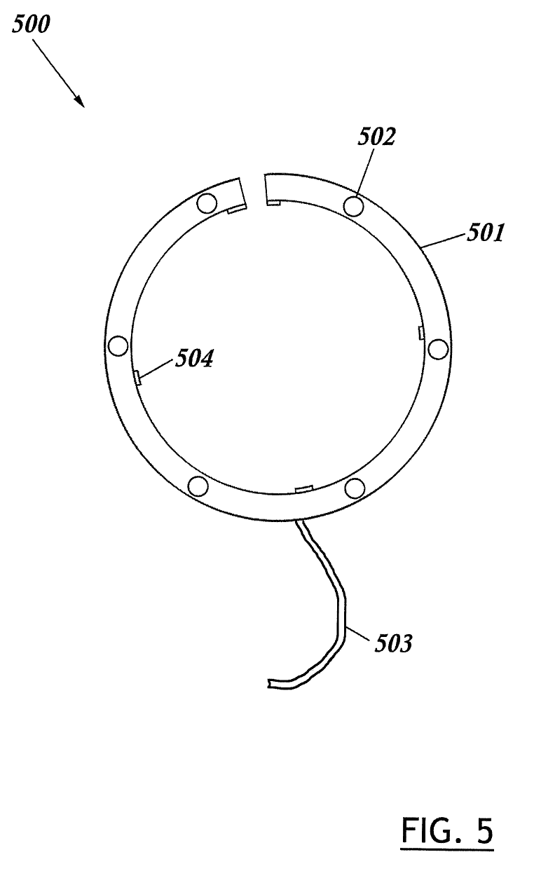

Another method of mounting an attracting member 500 is illustrated in FIG. 5. The attracting member 500 may include a semi-flexible ring 501 constructed so that it is relatively stiff and retains its form as shown in FIG. 5. The semi-flexible ring 501 may include a plurality of light sources (such as light source 502). The semi-flexible ring 501 may be flexible enough so that it may be opened up from the position shown in FIG. 5 by applying an opening force on the semi-flexible ring 501 and positioned about a lens. The opening force may then be removed and the semi-flexible ring 501 allowed to contract toward the position shown in FIG. 5, capturing a portion of the lens in the process. Such a method of mounting is analogous to a c-clip that may be mounted about a shaft. To help grip the lens, grip pads 504 may be interconnected to the semi-flexible ring 501.

Another method of mounting an attracting member may include a stretch ring. The stretch ring may include a plurality of light sources. The stretch ring may be flexible like a rubber band and be mounted by stretching the stretch ring to fit over a lens. The tension in the stretch ring would then act to secure the stretch ring to the lens, similar to a rubber band wrapped around a newspaper.

Another method of mounting an attracting member 601 is illustrated in FIG. 6. Frequently, cameras, particularly compact or point and shoot cameras, will have lenses which retract into the body of the camera when the camera is off. Such a camera 604 is illustrated in FIG. 6. In such a situation, it may be desirable to mount the attracting member 601 to the body of the camera 604 such that the attracting member 601 and its plurality of light sources (such as light source 607) surround a lens 605 when the lens 605 is in an extended position. The attracting member 601 may be interconnected to the camera 604 by means of hook and loop fasteners. For example, small patches of hook fasteners may be adhesively attached to the camera 604 near the lens 605. Corresponding patches of loop fasteners may be attached to the back of the attracting member 601. In this regard, the attracting member 601 may be interconnected to the camera by 604 aligning the hook and loop fastener patches and pressing the attracting member 601 onto the camera 604. For example, small patches 200 of loop fastener are illustrated on the back of the attracting member 101 shown in FIG. 2. Alternatively, the attracting member 601 of FIG. 6 may be permanently attached to the camera 604 using adhesive (e.g., double sided tape).

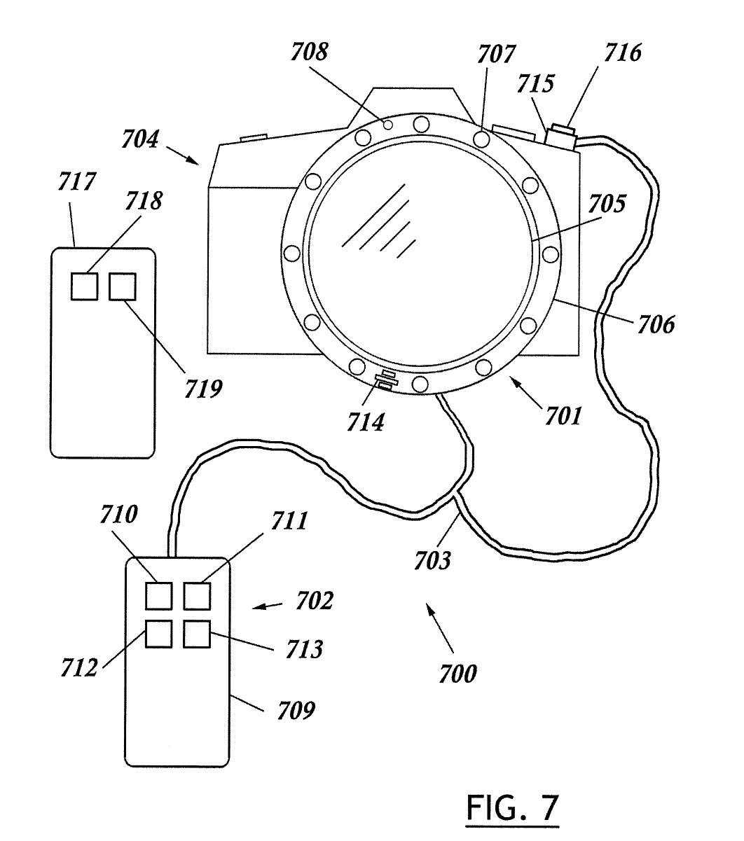

In a particular embodiment, a gaze attracting system may include sound production capabilities. For example, the gaze attracting system 700 of FIG. 7 may include a speaker 714 capable of producing sound. The speaker 714 may be mounted to the attracting member 701 to further grab the attention and attract the gaze of a subject toward a lens. The sound produced by the speaker 714 may be synchronized with the illumination of one or more of a plurality of light sources (such as light source 707) interconnected to the attracting member 701.

The gaze attracting system 700 of FIG. 7 includes a wireless remote control 717 operable to control the gaze attracting system 700. This may be beneficial where the photographer wishes to be positioned in a place other than with the image capturing equipment, such as in the field of view of the image capturing equipment so that the photographer may also be in the captured image. The wireless remote control 717 may be operable to send signals, such as an infrared signals, to a receiver 708 on the attracting member 701. The signals may cause one or more of the plurality of light sources of the attracting member 701 to be illuminated. The wireless remote control 717 may include buttons 718 and 719 to allow for remote access to various functions of the gaze attracting system 700.

The gaze attracting system 700 of FIG. 7 includes a wired remote button 716 operable to control the gaze attracting system 700. The wired remote button 716 may be mounted in a button mount 715 which may be operable to be mounted on the camera 704. A user may mount the button mount 715 in any desired position. The button mount 715 is interconnected to the gaze attracting system 700 via a cable 703.

For explanatory purposes, the illustrated embodiments all have control members and power sources that are remote from an attracting member. However, the attracting member may contain the power source and activation devices. For example, small button batteries may be mounted within the attracting member and a button to activate the plurality of light sources may be present on the attracting member, yielding a self contained gaze attracting system.

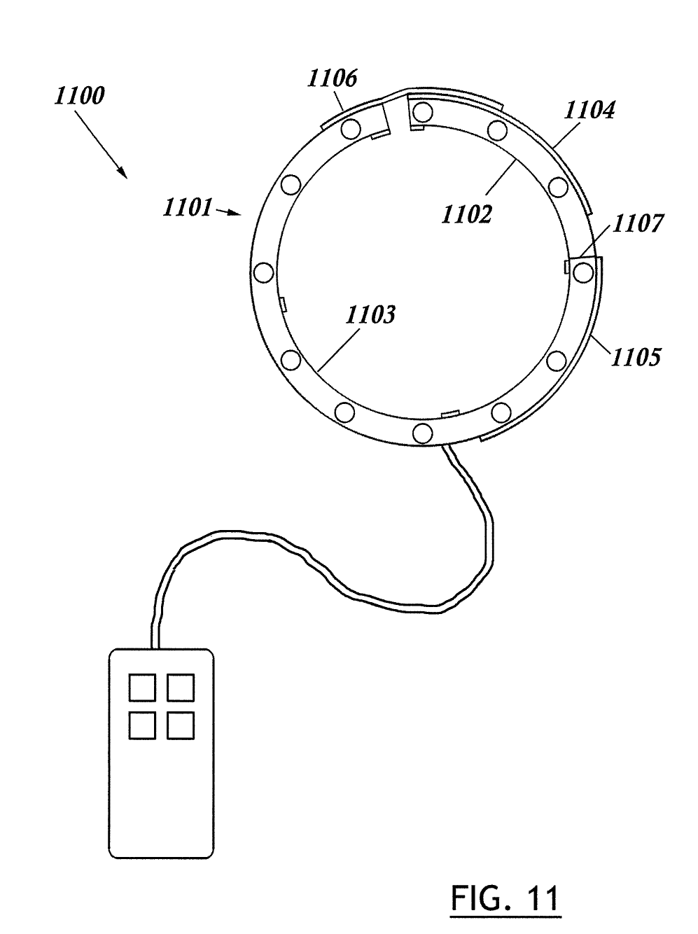

It will be appreciated that a typical lens of an SLR camera may be larger than the typical lens of a point and shoot camera. Turning to FIG. 11, to accommodate either type of camera and to accommodate a larger range of lens sizes, a gaze attracting system 1100 may include an attracting member 1101 that may include a removable and replaceable section 1102. The gaze attracting system 1100 of FIG. 11 is similar to the gaze attracting system 100 of FIG. 1 with the additional feature of the removable and replaceable section 1102. The interface 1107 between the removable and replaceable section 1102 and the main section 1103 of the attracting member 1101 may be a multi-conductor plug and socket or any other appropriate mechanical/electrical interconnection. The attracting member 1101 may include a first and a second strip of loop fastening material 1104, 1105 attached to the attracting member 1101. When the removable and replaceable section 1102 is present, a strip of hook fastening material 1106 may interface with the first strip of loop fastening material 1104 to configure the attracting member 1101 for use with relatively larger lenses such as those typically associated with SLR cameras. When the removable and replaceable section 1102 is not present, the strip of hook fastening material 1106 may interface with the second strip of loop fastening material 1105 to configure the attracting member 1101 for use with relatively smaller lenses such as those typically associated with point and shoot cameras.

The light intensity produced by the plurality of light sources may be selected such that it is below a threshold where the output of the light sources may affect a typical captured image. In this regard, if any of the plurality of light sources are on at the moment of image capture, the image will be substantially unaffected. In instances where the output of the plurality of light sources may affect the captured image, the photographer may avoid illuminating the plurality of light sources at the moment of image capture (e.g., by releasing the activation button prior to image capture). In an embodiment, the gaze attracting system may be integrated into the image capture device in such a way that the plurality of light sources automatically turn off during image capture. For example, in an embodiment, the combined light output of all of the plurality of light sources may be at most 1,000 millicandela. For further example, the combined light output of all of the plurality of light sources may be at most 100 millicandela.

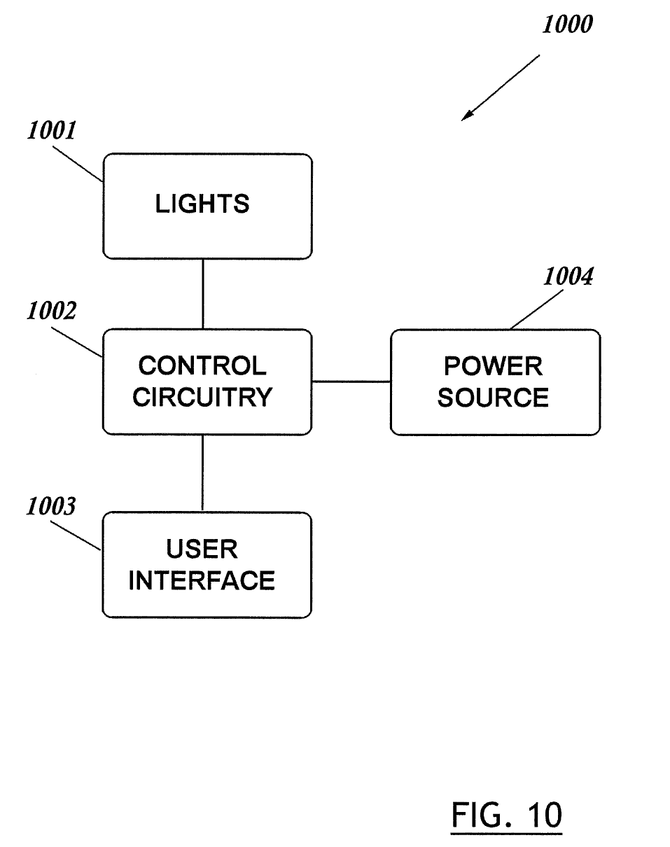

FIG. 10 is a functional block diagram of a gaze attracting system 1000, such as the gaze attracting system 100 of FIGS. 1 and 2. The gaze attracting system 1000 includes light sources 1001 to attract the gaze of a subject. The gaze attracting system 1000 further includes a user interface 1003 through which the user activates the light sources 1001. The gaze attracting system 1000 further includes a power source 1004 that provides power to illuminate the light sources 1001. The power source may be any appropriate number and type of batteries as described herein. The gaze attracting system 1000 may further include optional control circuitry 1002. The control circuitry may be located in a particular component, such as the control member 102 and/or attracting member 101 of the embodiment of FIGS. 1 and 2, or it may be distributed (e.g., elements of the control circuitry 1002 may be collocated with the light sources 1001 and the user interface 1003).

As noted, the control circuitry 1002 is optional. In an embodiment without control circuitry 1002, the user interface may consist of a single button that when depressed electrically connects the power source 1004 to the light source 1001, thereby illuminating the light sources 1001.

In embodiments that include control circuitry 1002, various levels of functionality are possible. The control circuitry 1002 may be operable to flash or sequentially light one or more of the light sources 1001 in response to an input signal from the user interface 1003. For example, with reference to the embodiment of FIG. 1, activating one of the buttons 110, 111, 112, and 113, of the control member 102 may send a signal to the control circuitry 1002 which then illuminates one or more of the light sources 1001 in a predetermined pattern while that button is activated (e.g., depressed). Alternatively, in response to activation of one of the buttons 110, 111, 112, and 113, the control circuitry 1002 may illuminate one or more of the light sources 1001 in a predetermined pattern for a fixed period of time. Alternatively, in response to activation of one of the buttons 110, 111, 112, and 113, the control circuitry 1002 may illuminate one or more of the light sources 1001 in a predetermined pattern until the activated button is pressed again to cancel the illumination. Such a control method may include an automatic shut off if the control button has not been pressed within a predetermined amount of time. In an embodiment, the pressing of an button may cause the control circuitry to light one or more of the light sources 1001 in a random pattern or sequence.

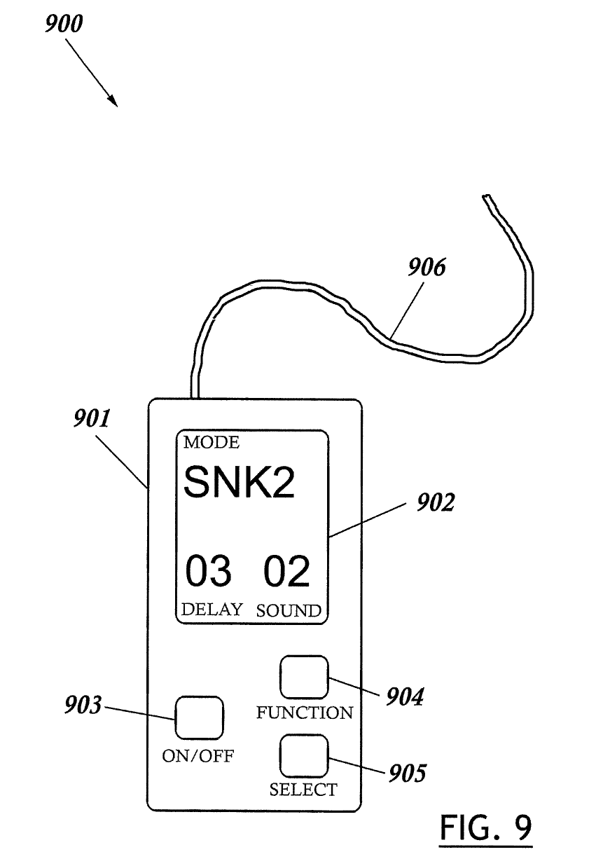

FIG. 9 illustrates a relatively sophisticated control member 901 that may be part of a gaze attracting system 900 that may be interconnected to an attracting member via a cable 906. The control member 901 may include a display 902 (e.g., a liquid crystal display) that communicates information to a user. For example and as illustrated in FIG. 9, the display 902 may display the current mode of lighting. Lighting modes are discussed below. The display 902 may further indicate a delay, which may correspond to the amount of time the light sources will be activated after pressing an on/off button 903. The display may further indicate which sound may be played along with the activated lighting mode when the on/off button 903 is pressed.

The on/off button 903 may function in a variety of ways. For example, momentarily pressing the on/off button 903 may result in the light sources being activated for a predetermined period of time. A momentary pressing of the on/off button 903 while the light sources are activated may result in the light sources being deactivated. A sustained pressing of the on/off button 903 may result in the light sources being activated until the on/off button 903 is released.

The control member 901 may also include a function button 904. The function button 904 may be used to select an attribute to be changed. For example, pressing the mode button once may cause the mode in the display 902 to blink to indicate that the mode may now be changed by depressing a select button 905. Repeated depressions of the select button 905 may result in paging through the various available modes, which will be indicated on the display 902. Pressing the function button 904 repeatedly may sequentially select the mode, the delay, and the sound functions, which may then be changed by pressing the select button 905. Other features and functions may be controllable by the control member 901. Also, fewer features than those described may be accessible by the control member 901 (e.g., a particular control member 901 may not include the sound function).

The various gaze attracting systems described herein may be operable to function in a variety of ways. The variety of ways may each be operable to attract the gaze of a subject. This may be accomplished, for example, by the brightness of the light sources, flashing of the light sources, and/or simulated motion by the light sources. Other attributes of the control of the light sources may also attract the gaze of a subject. Having a plurality of different modes for attracting a gaze of a subject may be beneficial. For example, a subject, such as an infant, may get used to seeing a particular pattern of lighting displayed by the gaze attracting system. Once this occurs, the subject may not pay as much attention to the particular pattern and the particular pattern may become less effective at attracting the gaze of the subject. At such a point, it may be beneficial to activate a different pattern of lighting. The different pattern may appear new to the subject and the subject's interest and gaze may be attracted to the different pattern. In this manner, multiple modes may be used to sustain the effectiveness of the gaze attracting system at attracting the gaze of a particular subject.

Moreover, having different modes may enable the gaze of different subjects to be attracted. For example, a particular lighting mode may be of little interest to a particular subject. In such a situation, another mode of lighting may be more interesting to that subject and may therefore be effective of attracting the gaze of that particular subject.

Several modes of lighting will now be described. A simple mode of lighting may be where depressing a button on a control member causes all of the light sources of the attracting member to illuminate while the button is depressed. In such a mode, the light sources of the attracting member may be flashed by repeatedly depressing and releasing the button.

Another mode may be where depressing the button causes all of the light sources of the attracting member to illuminate for a preset amount of time. The preset amount of time may be fixed or it may be adjustable. Yet another mode may be all of the light sources of the attracting member automatically flash in unison at a predetermined rate while an activation button is depressed. In a related mode, all of the light sources of the attracting member may automatically flash in unison at a predetermined rate for a predetermined amount of time in response to depressing an activation button.

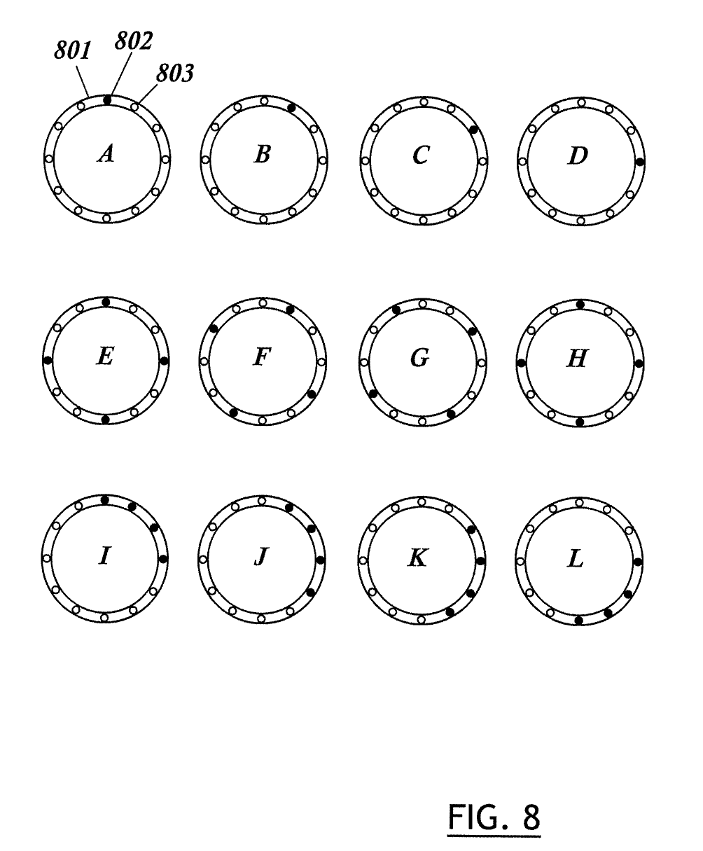

Additional modes of lighting will now be described with reference to FIGS. 8A through 8L. A mode of operation may comprise sequentially lighting a single one of the light sources of the attracting member to give the appearance of the light source traveling along the attracting member. Such a mode is illustrated in FIGS. 8A through 8D. FIG. 8A illustrates an attracting member 801 in which a single light source is illuminated. In FIGS. 8A through 8L, an illuminated light source is represented by a solid black circle, such as circle 802, and non-illuminated light sources are represented by non-filled circles, such as circle 803. At a first point in time represented by FIG. 8A, a single light source may be illuminated. At a the second point in time represented by FIG. 8B, a single light source next to the previously illuminated light source may be illuminated. Similarly, at a third point in time represented by FIG. 8C, a single light source next to the previously illuminated light source may be illuminated. The pattern may be continued at a fourth point in time represented by FIG. 8D. This pattern of lighting a single light source at a time in a sequential order may continue, giving the appearance of a single light source traveling around a lens encircled by the attracting member.

FIGS. 8E through 8H illustrate an additional mode of lighting the light sources of the attracting member. In FIG. 8E, four light sources may be illuminated at once. The four light sources may include two pairs of light sources in opposing positions. At a subsequent moment in the sequence, four other light sources, each of which is adjacent to one of the light sources illustrated at the previous moment, may be illuminated as illustrated in FIG. 8F. At a subsequent moment, illustrated in FIG. 8G, four other light sources, each of which is adjacent to one of the light sources illustrated at the previous moment, may be illuminated. Next, the four light sources originally illuminated may again be illuminated as shown in FIG. 8H. Such a sequence of lighting may give the appearance of separate light sources traveling around the periphery of the lens. Such a pattern of lighting is referred to herein as a pinwheel pattern. Although the illustrated pinwheel pattern shows four light sources illuminated simultaneously, other quantities of light sources may be simultaneously illuminated. For example, only two light sources may be simultaneously lighted giving the appearance of a two-pronged pinwheel spinning about the lens, as opposed to the four-pronged pinwheel illustrated in FIGS. 8E through 8H.

FIGS. 8I through 8L illustrate an additional mode of lighting. At a first point in time, illustrated by FIG. 8I, four consecutively disposed light sources may be simultaneously illuminated. At the second point of the time illustrated in FIG. 8J, one of the light sources on one end of the four consecutively disposed light sources may be not illuminated while an additional light source on the other end of the four consecutively disposed light sources may be illuminated. As illustrated in FIGS. 8I and 8J, this may give the appearance that the string of four illuminated light sources has moved in a clockwise direction. This pattern may be repeated at a third point in time, illustrated in FIG. 8K, giving the illusion that the string of four illuminated light sources has continued to move in a clockwise direction. This pattern may be repeated at a fourth point in time, illustrated in FIG. 8L. The pattern illustrated in a FIGS. 8I through 8L may continue to be repeated giving the appearance of a string of four light sources circling the lens. Such a pattern of lighting is referred to herein as a snake pattern. Two or more “snakes” may be simultaneously displayed by the attracting member.

Although the illustrated modes of lighting of FIGS. 8A through 8L all the picture light sources moving into a clockwise direction, patterns where the light sources are perceived to move in a counterclockwise direction are also contemplated. Furthermore in patterns where multiple light sources are perceived to be rotating about the lens, such as a pinwheel pattern, portions of the light sources may be illuminated in such a manner as to give the perception of light sources moving in a clockwise direction while simultaneously illuminating light sources in such a manner as to give the perception of other light sources moving in a counterclockwise direction. Additionally, the various sequences described above may be performed at various speeds, thus giving the impression of light sources traveling around the lens at various speeds. Furthermore, the speed may be dynamically changed such that the light source or light sources are perceived to slow down and speed up as they travel about the lens.

Also, the inverse patterns of those described above are also contemplated. By way of example, if in FIGS. 8A through 8D, an illuminated light source may be represented by non-filled circles (opposite as discussed above), such as circle 803, and non-illuminated light sources may be represented by filled circles, such as circle 802, the sequence illustrated by FIGS. 8A through 8D may give the appearance of a dark space (represented by the non-illuminated light source) traveling around the periphery of the lens.

Other illumination modes may be possible. For example, depressing of an activation button may cause light sources to go on and off in a random pattern. For further example, depressing of an activation button might cause light sources to illuminate in one of the above patterns where the pattern is selected randomly.

An exemplary set of operational modes will now be described with reference to FIGS. 1 and 8. For example, depressing button 110 may result in all of the light sources 107A through 107L simultaneously being illuminated as long as the button 110 is depressed. In the current example, depressing button 111 may result in all of the light sources 107A through 107L simultaneously flashing at a predetermined rate. Furthermore in the current example, depressing button 112 may result in the light sources 107A through 107L being illuminated in a pinwheel pattern as previously described with reference to the FIGS. 8E through 8H. Furthermore in the current example, depressing button 113 may result in the light sources 107A through 107L being illuminated in a pinwheel pattern as previously described with reference to the FIGS. 8E through 8H but at a different perceived movement rate than that produced by depressing button 112. The present exemplary set of operational modes may only require cable 108 to comprise four conductors since the pinwheel pattern of illumination shown in FIGS. 8E through 8H may allow for the plurality of light sources 107A through 107L to be divided into 3 subgroups of four light sources each (for example, light sources 107A, 107D, 107G, and 107J may comprise a subgroup). Each of these three subgroups may be wired in series and controlled through a single conductor with in the cable 108. The fourth conductor may be a return conductor (e.g. ground). In contrast, to illuminate a pattern such as the pattern described with reference to FIGS. 8A through 8D may require the cable 108 to carry an individual conductor connected to each of the plurality of light sources 107A through 107L plus a return conductor (alternatively pattern generating electronics may be disposed within the flexible strip 103 as opposed to within the control number 102).

Additional variations to the above-described embodiments are contemplated. For example, different colored light sources (i.e., non-white light producing light sources) may be used within the attracting members. Alternatively, a single color of light sources, such as red, may be utilized.

The gaze attracting system may be integrated into a camera or lens unit. For example, the buttons controlling the system and the system control functions may be on board the camera. The gaze attracting system may be powered by the power source for the camera. The gaze attracting system may be powered by a separate button or buttons on board the camera. In another variation, the gaze attracting system may be activated by a partial activation of the shutter release button of the camera (or the button that initiates the image capture sequence in a digital camera). In many cameras the partial activation of the shutter release button will also activate autofocus and light metering functions. Furthermore, in such an integrated system, the plurality of light sources of the gaze attracting system may be controlled such that they are automatically turned off at the moment of shutter release and/or image capture.

A method of capturing an image with a camera of a subject where the subject is gazing at the lens of the camera includes the step of providing a plurality of light sources disposed proximate to and about the lens of the camera. The providing step may be followed by illuminating at least a portion of the plurality of light sources to attract the gaze of the subject to the lens of the camera. The present method may further include capturing an image of the subject while the gaze of the subject is directed toward the lens of the camera. The illuminating of at least a portion of the plurality of light sources may include flashing at least a portion of the plurality of light sources or sequentially lighting portions of the plurality of light sources. During the performance of the illuminating step, portions of the plurality of light sources may be flashed a plurality of times. The method may include turning off the plurality of light sources during the step of capturing an image of the subject.

Additional modifications and extensions to the embodiments described herein will be apparent to those skilled in the art. Such modifications and extensions are intended to be within the scope of the present invention as defined by the claims that follow.

1. An apparatus for attracting the gaze of a subject during capture of an image of said subject, said apparatus comprising:
a power source;
a plurality of light sources operable to be interconnected about a lens of an imaging device; and
a switch interconnected to said power source and said plurality of light sources, wherein activation of said switch results in at least a portion of said plurality of light sources being illuminated.

2-3. (canceled)

4. The apparatus of claim 1, wherein each of said plurality of light sources is an LED.

5. The apparatus of claim 1, wherein each of said plurality of light sources is a colored light source.

6. The apparatus of claim 1, wherein said plurality of light sources are operable to be arranged in circular pattern.

7. The apparatus of claim 6, wherein a diameter of said circular pattern is adjustable.

8-18. (canceled)

19. The apparatus of claim 1, wherein the total maximum luminous intensity of all of said plurality of light sources combined is at most 1,000 millicandela.

20. The apparatus of claim 19, wherein the total maximum luminous intensity of all of said plurality of light sources combined is at most 100 millicandela.

21. The apparatus of claim 1, wherein activation of said switch results in two or more of said plurality of light sources to be sequentially illuminated.

22. The apparatus of claim 1, wherein activation of said switch results in said plurality of light sources being illuminated in a pattern that simulates movement about said lens when said plurality of light sources are interconnected about said lens.

23. The apparatus of claim 1, wherein said switch is a momentary closure switch and activation of said switch causes each of said plurality of light sources to be illuminated while said switch is activated.

24. (canceled)

25. The apparatus of claim 1, further including a sound module, said sound module comprising:
a speaker;
a playback device operable to drive said speaker; and
a memory operable to store information related to one or more sounds to be played by said playback device over said speaker.

26. (canceled)

27. An apparatus for attracting the gaze of a subject during capture of an image of said subject, said apparatus comprising:
a power source;
a plurality of light sources operable to be interconnected about a lens of an imaging device; and
a control module operable to flash one or more of said plurality of light sources.

28-35. (canceled)

36. The apparatus of claim 27, wherein said control module is operable to individually control a sub-group of said plurality of light sources.

37. (canceled)

38. The apparatus of claim 27, wherein said control module is operable to sequentially light two or more of said plurality of light sources.

39. The apparatus of claim 27, wherein said control module is operable to light said plurality of light sources in a pattern that simulates movement about said lens when said plurality of light sources are interconnected about said lens.

40. (canceled)

41. The apparatus of claim 27, wherein said control module is operable to flash one or more of said plurality of light sources a plurality of times after receiving an initiation signal.

42-69. (canceled)

70. A method of capturing an image of a subject with a camera wherein said subject is gazing at a lens of said camera, said method comprising:
providing a plurality of light sources disposed proximate to and about said lens;
illuminating at least a portion of said plurality of light sources to attract said gaze of said subject to said lens; and
capturing an image of said subject while said gaze of said subject is directed at said lens.

71. The method of claim 70, wherein said illuminating includes flashing at least a portion of said plurality of light sources.

72. (canceled)

73. The method of claim 70, wherein said illuminating is in a pattern that simulates movement about said lens.

74. The method of claim 70, wherein said light sources are not illuminated during said capturing step.
